(19) United States
(12) Patent Application Publication
(10) Pub. No.: US 2009/0283024 A1
(43) Pub. Date: Nov. 19, 2009

(54) Battery Keel System and Method

(76) Inventor: William Joseph Robertson, Grand Rapids, MI (US)

Correspondence Address: William Joseph Robertson, 2908A Buckingham Rd. NW, Wilson, NC, 27896, US

(21) Appl. No.: 12/018,799

(22) Filed: Mar. 18, 2008

(51) Int. Cl. B63B 3/38; H01M 10/44

(52) U.S. Cl. 114/140; 429/50

(57) ABSTRACT

A battery keel system for providing electrical power and ballast to a water vessel wherein the system comprises a keel including a cavity, at least one electrochemical cell and at least one electrical circuit extending from the electrochemical cell. The at least one electrochemical cell is positioned within the cavity, such that the electrochemical cell provides electrical power and ballast to the water vessel.

This application claims the benefit of the filing date of U.S. provisional application Ser. No. 60/886275 entitled “Water Vessel Battery Keel” which was filed on Jan. 23, 2007 and which is herein incorporated by reference.

### BACKGROUND OF THE INVENTION

This invention relates to a battery for water vessels. More particularly, the invention relates to a combined battery keel system for water vessels.

Typically, batteries on water vessels are used to power lights, radio, refrigeration, navigational tools and electronics. A battery, conventionally stored in the ship's hull space, must be large enough to provide sufficient power for these tasks while away from shore power or while not drawing power from the engine's charging system. However, as hull space on a ship is limited, the size of a battery on a conventional water vessel is similarly limited.

Many water vessels employ some form of ballast to provide stability and righting moment. Keels, constructed of high-density materials such as lead, iron, or other heavy materials are used as ballast for many water vessels. Positioning this ballast to lower the center of gravity of the water vessel adds stability and improves the self righting ability of the vessel. As a general rule, the lower the center of gravity of the vessel the better the self-righting ability becomes. These materials are used in various forms of keel designs, including: fixed keels, retractable keels, and canting keels, among others.

When the weight of the battery, contributing to ballast, is disposed at a lower position in the water vessel, i.e. below the water line of the vessel, the weight of the battery contributes to the righting moment and vessel stability. The electrochemical cell in the present invention is not limited to any one type of electrochemical cell, and includes all electrochemical cells known in the art that fit the specific requirements of a particular design.

Accordingly, a need exists for novel systems and methods that have, among other advantages, providing increased power storage capacity and increased available hull space, while providing necessary stability to a water vessel. Therefore, a battery keel system that solves the aforementioned disadvantages and having the aforementioned advantages is desired.

### SUMMARY OF THE PRESENT INVENTION

The aforementioned drawbacks and disadvantages of conventional water vessel battery systems have been identified and a solution is set forth herein by the inventive battery keel system for providing electrical power and ballast to a water vessel wherein the system comprises a keel including a cavity, at least one electrochemical cell and at least one electrical circuit extending from the electrochemical cell. The at least one electrochemical cell is positioned within the cavity, such that the electrochemical cell provides electrical power and ballast to the water vessel.

Another aspect of the present invention includes a method for providing electrical power and ballast to a water vessel, wherein the method comprises providing a keel, the keel including a cavity, providing at least one electrochemical cell and providing at least one electrical circuit. The method further includes inserting the at least one electrochemical cell within the cavity, connecting the at least one electrical circuit to the at least one electrochemical cell, wherein the electrochemical cell provides electrical power and ballast to the water vessel.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the battery keel system and method of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U. S. Patent and Trademark Office and the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the battery keel system and method of the present disclosure, its advantages, and the specific objects attained by its uses, reference should be made to the accompanying drawings and descriptive matter in which there are illustrated and described the preferred embodiments of the invention.

As such, while embodiments of the battery keel system and method are herein illustrated and described, it is to be appreciated that various changes, rearrangements and modifications may be made therein, without departing from the scope of the invention as defined by the claims.

### BRIEF DESCRIPTION OF THE DRAWINGS

As a compliment to the description and for better understanding of the specification presented herein, 1 page of drawings are disclosed with an informative, but not limiting, intention.

FIG. 1 is a perspective view of an embodiment of the battery keel system of the present invention.

FIG. 2 is a schematic flow chart illustrating a method according to the invention;

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

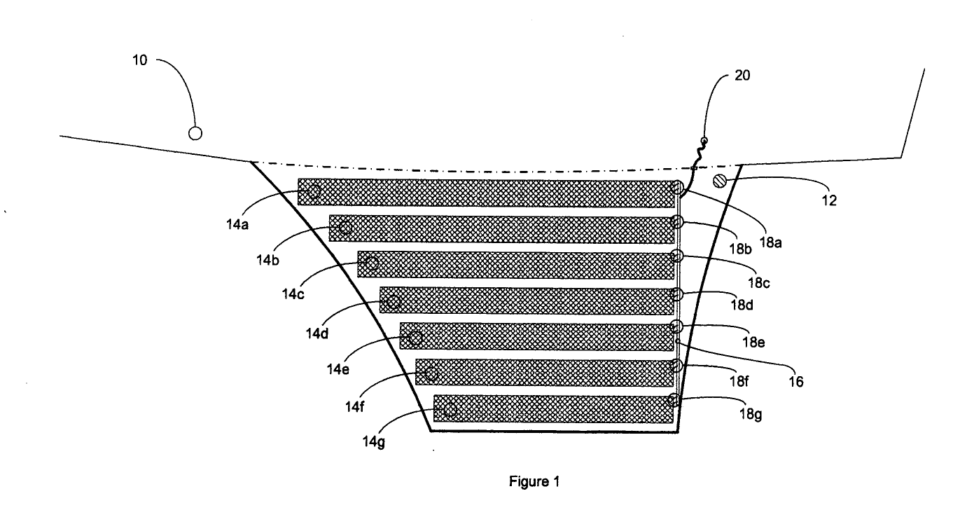

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings, which are illustrated in hidden or dashed lines, are to be considered as forming no part of the present invention.

As used herein, the term, keel can refer to either of two parts: a structural element, or a hydrodynamic element. These parts can overlap. The keel surface on the bottom of the hull gives the ship greater directional control and stability. In non-sailing hulls, the keel helps the hull to move forward, rather than slipping to the side. In sailboats, keels use the forward motion of the boat to generate lift to counter the lateral force from the sails. Keels are made of heavy materials to provide ballast to stabilize the boat. Keels may be fixed, or non-movable, or they may retract to allow sailing in shoal waters.

As used herein, the term keel refers to any structural or hydrodynamic element, used to provide ballast to a water vessel, including centerboards and daggerboards. Of course, this is not meant to be limiting in any manner and these vehicles may take on numerous configurations, and may be used for numerous purposes as is generally known within the art.

As used herein, the term electrical circuit is to be understood to include, one or more electrical leads for connecting the at least one electrochemical cell to an electrical load, or for connecting the at least one electrochemical cell to an external power source for charging. The electrical connector should also be understood by to include any interface or circuit, such as, an electrical bus, a DC to AC power inverter, or the like that allows electrical power to be distributed from the at least one electrochemical cell to an electrical load or loads.

As used herein, the term electrochemical cell is meant to refer to a device used for creating an electromotive force (voltage) and current from chemical reactions. A common example of an electrochemical cell is a battery.

Typically, batteries on water vessels are used to power lights, radio, refrigeration, navigational tools and electronics. A battery, conventionally stored in the ship's hull space, must be large enough to provide sufficient power for these tasks while away from shore power or while not drawing power from the engine's charging system. However, as hull space on a ship is limited, the size of a battery on a conventional water vessel is similarly limited.

Many water vessels employ some form of ballast to provide stability and righting moment. Keels, constructed of high-density materials such as lead, iron, or other heavy materials are used as ballast for many water vessels. Positioning this ballast to lower the center of gravity of the water vessel adds stability and improves the self righting ability of the vessel. As a general rule, the lower the center of gravity of the vessel the better the self-righting ability becomes. These materials are used in various forms of keel designs, including: fixed keels, retractable keels, and canting keels, among others.

When the weight of the battery, contributing to ballast, is disposed at a lower position in the water vessel, i.e. below the water line of the vessel, the weight of the battery contributes to the righting moment and vessel stability. The electrochemical cell in the present invention is not limited to any one type of electrochemical cell, and includes all electrochemical cells known in the art that fit the specific requirements of a particular design.

Accordingly, a need exists for novel systems and methods that have, among other advantages, providing increased power storage capacity and increased available hull space, while providing necessary stability to a water vessel. Therefore, a battery keel system that solves the aforementioned disadvantages and having the aforementioned advantages is disclosed herein.

The disadvantages and drawbacks of the prior art are overcome through the battery keel system and method of the present invention, wherein one preferred embodiment is disclosed in FIGS. 1-3. Referring now to FIG. 1, there is shown the inventive battery keel system and method for providing electrical power and ballast to a water vessel wherein the system comprises a keel including a cavity, at least one electrochemical cell and at least one electrical circuit extending from the electrochemical cell. The at least one electrochemical cell is positioned within the cavity, such that the electrochemical cell provides electrical power and ballast to the water vessel.

In one embodiment, as shown in FIG. 1, a water vessel comprises a keel 12, attached to the hull 10 of vessel. Keel 12 comprises electrochemical cells 14a-14g. Electrochemical cells 14a-14g are affixed to electrical bus connections 18a-18g. Bus connections 18a-18g are connected to electrical bus 16 which terminates into electrical bus leads 20, providing access to the stored battery power. In FIG. 1 electrochemical cells 14a-14g are connected in a parallel configuration, but the invention is not limited to this specific configuration. The electrochemical cells may be connected in parallel or series configuration, or any combination thereof.

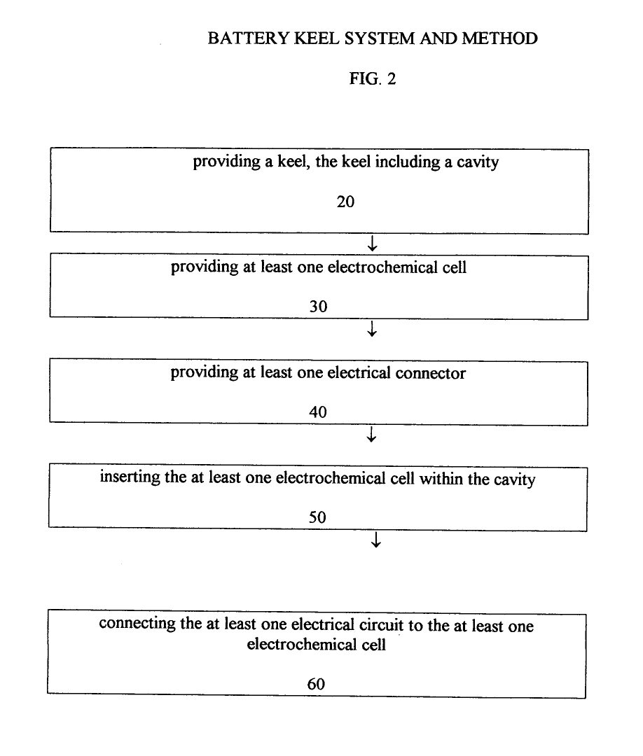

A method of building a battery keel system of the present invention is also contemplated. In one embodiment, as shown in FIG. 2, the invention contemplates a method for providing electrical power and ballast to a water vessel, wherein the method comprises providing a keel, the keel including a cavity, providing at least one electrochemical cell and providing at least one electrical circuit. The method further includes inserting the at least one electrochemical cell within the cavity, connecting the at least one electrical circuit to the at least one electrochemical cell, wherein the electrochemical cell provides electrical power and ballast to the water vessel.

The battery may be preformed and self-contained. In another embodiment of the present invention, electrochemical cell 14 may be integrally constructed into keel 12, wherein the ballasting material of keel 12 functions as the shell of the electrochemical cell 14 for the purpose of containing electrochemical cell 14 components. The ballast material, comprised of suitable conductive material, of the battery keel 12 may also be utilized as the electrodes of the integral electrochemical cell 14.

Conductive material used in forming battery keel 12 may comprise lead, lead based compounds, nickel, nickel based compounds, cadmium, cadmium based compounds, copper, copper based compounds, aluminum, aluminum based compounds, lithium, lithium based compounds, silver, silver based compounds, iron, iron based compounds, or a combination thereof. More specifically, in a lead-acid battery, portions of battery keel 12 may be formed from lead and lead dioxide. In a nickel cadmium battery, the portions of battery keel 12 may be formed from cadmium and nickel oxide hydroxide. In a nickel iron battery, the portions of battery keel 12 may be formed from iron and nickel oxide hydroxide. Of course, this is not meant to be limiting in any manner and portions of the keel may comprise any conductive material that may suitably function as electrodes in electrochemical cell 14.

Advantageously, the inventive battery keel system of the present invention provides battery power without the typical loss of hull space, while simultaneously contributing to the ballast needed to maintain proper stability of a water vessel. The inventive battery keel system of the present invention may also be used to depart from conventional propulsion systems such as diesel or gasoline engines in favor of electric propulsion.

The construction of the present invention may vary according to specific requirements. Also, it is to be understood that the phraseology and terminology employed herein are for description and not limitation.

As such, those skilled in the art will appreciate that the conception, upon which this disclosure is based, may readily be used as a basis for designing other structures, methods, and systems for carrying out the several purposes of the present invention. It is important, therefore, that this disclosure is regarded as including such equivalent constructions as far as they do not depart from the spirit and scope of the present invention.

Advantageously, the battery keel system and method of the present invention is efficiently fabricated and elegantly designed while being engineered to increase power storage, hull space, and stability. Consequently, the embodiments of the preferred invention disclosed herein reveal a battery keel system and method that has taken multiple necessary functions and reduced them into one efficient device. The solutions offered by the invention disclosed herein have thus been attained in an economical, practical, and facile manner. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A system for providing electrical power and ballast to a water vessel, the system comprising:
a keel;
the keel including a cavity;
at least one electrochemical cell;
the at least one electrochemical cell positioned within the cavity;
at least one electrical circuit extending from the at least one electrochemical cell;
wherein the electrochemical cell provides electrical power and ballast to the water vessel.

2. The system of claim 1, wherein the at least one electrochemical cell comprises a lead acid battery.

3. The system of claim 1, wherein the at least one electrochemical cell comprises a nickel-cadmium battery.

4. The system of claim 1, wherein the at least one electrochemical cell is self-contained.

5. The system of claim 1, wherein a portion of the keel comprises a conductive material.

6. The system of claim 5, wherein the conductive material comprises lead, lead based compounds, nickel, nickel based compounds, cadmium, cadmium based compounds, copper, copper based compounds, aluminum, aluminum based compounds, lithium, lithium based compounds, silver, silver based compounds, iron, iron based compounds, or a combination thereof.

7. The system of claim 5, wherein the portion of the keel functions as an electrode for the at least one electrochemical cell.

8. The system of claim 6, wherein the portion of the keel functions as an electrode for the at least one electrochemical cell.

9. A method for providing electrical power and ballast to a water vessel, the method comprising:
providing a keel;
the keel including a cavity;
providing at least one electrochemical cell;
providing at least one electrical connector;
inserting the at least one electrochemical cell within the cavity;
connecting the at least one electrical circuit to the at least one electrochemical cell;
wherein the electrochemical cell provides electrical power and ballast to the water vessel.

10. The method of claim 9, wherein the at least one electrochemical cell comprises a lead acid battery.

11. The method of claim 9, wherein the at least one electrochemical cell comprises a nickel-cadmium battery.

12. The method of claim 9, wherein the at least one electrochemical cell is self-contained.

13. The method of claim 9, wherein a portion of the keel comprises a conductive material.

14. The method of claim 13, wherein the conductive material comprises lead, lead based compounds, nickel, nickel based compounds, cadmium, cadmium based compounds, copper, copper based compounds, aluminum, aluminum based compounds, lithium, lithium based compounds, silver, silver based compounds, iron, iron based compounds, or a combination thereof.

15. The method of claim 13, wherein the portion of the keel functions as an electrode for the at least one electrochemical cell.

16. The system of claim 14, wherein the portion of the keel functions as an electrode for the at least one electrochemical cell.
